(19) United States
(12) Patent Application Publication
(10) Pub. No.: US 2008/0084316 A1
(43) Pub. Date: Apr. 10, 2008

(54) Animal Potty Alarm Garment

(76) Inventor: Ian B. Panton, Los Altos Hills, CA (US)

Correspondence Address: Ian B.Panton, 24802 Olive Tree Ln, Los Altos Hills, CA, 94024, US

(21) Appl. No.: 11/902,540

(22) Filed: Sep. 24, 2007

Related U.S. Application Data
(60) Provisional application No. 60/849,817, filed on Oct. 6, 2006.

(51) Int. Cl. G08B 23/00

(52) U.S. Cl. 340/573.3

(57) ABSTRACT

An electronic potty training garment for animals. It detects initialization of urine and/or stool passage & sets off a loud audible alarm Approximately 90 dB. This negative enforcement alarm startles the animal, & instantly interrupts and/or stops urination and/or defecation. The alarm also alerts owner of attempt at the exact same moment. This allows the owner to “catch them in the act”, and place them in proper elimination environment for positive reinforcement or rewards/treats by owner/trainer. The garment worn by the animal allows stool and urination to pass unimpeded. Garment is not soiled with urination or defecation. Optional switch on garment to disarm alarm or remove garment once outside or in preferred elimination environment.

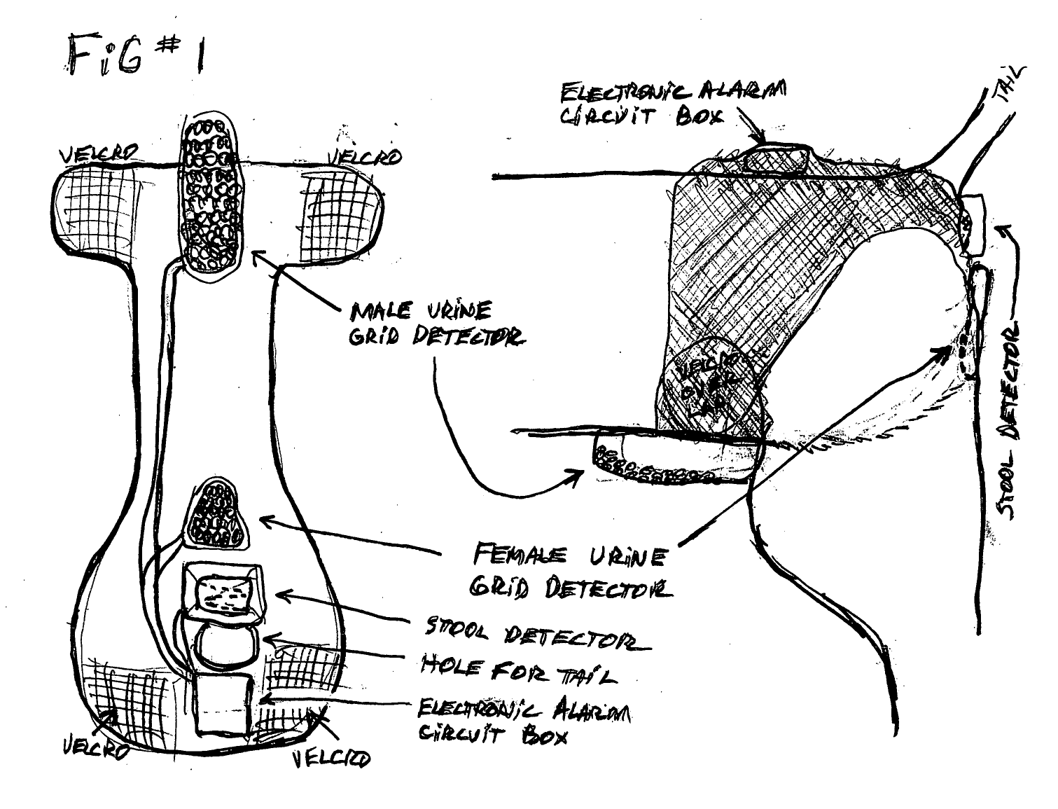

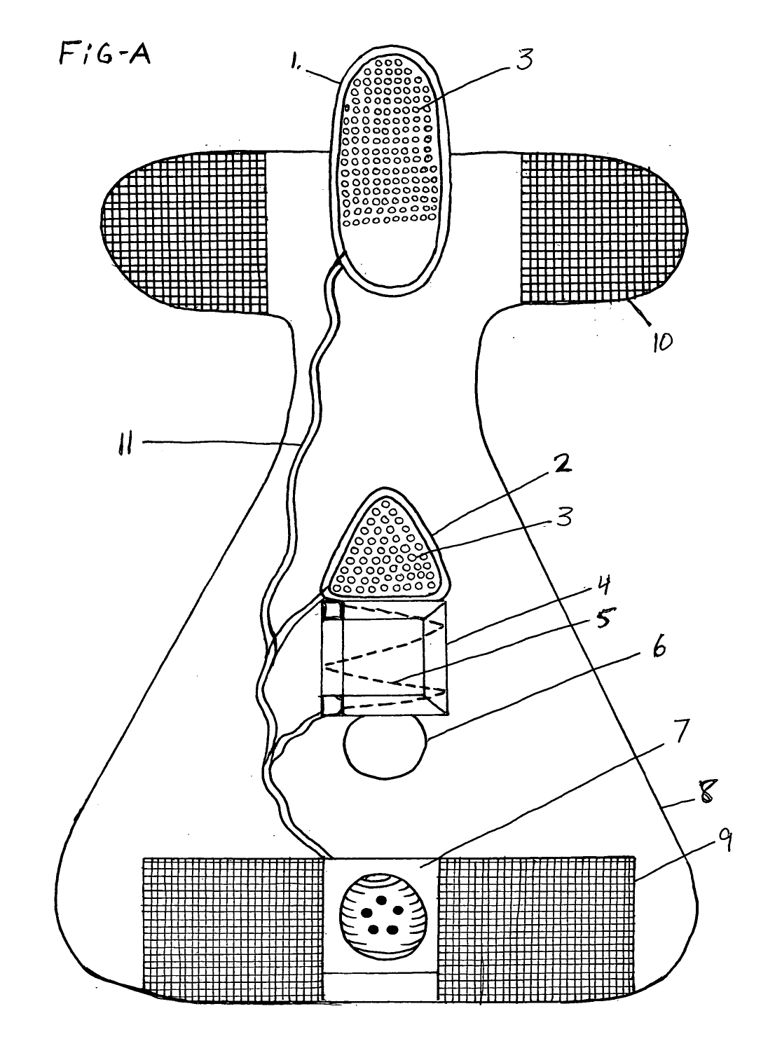

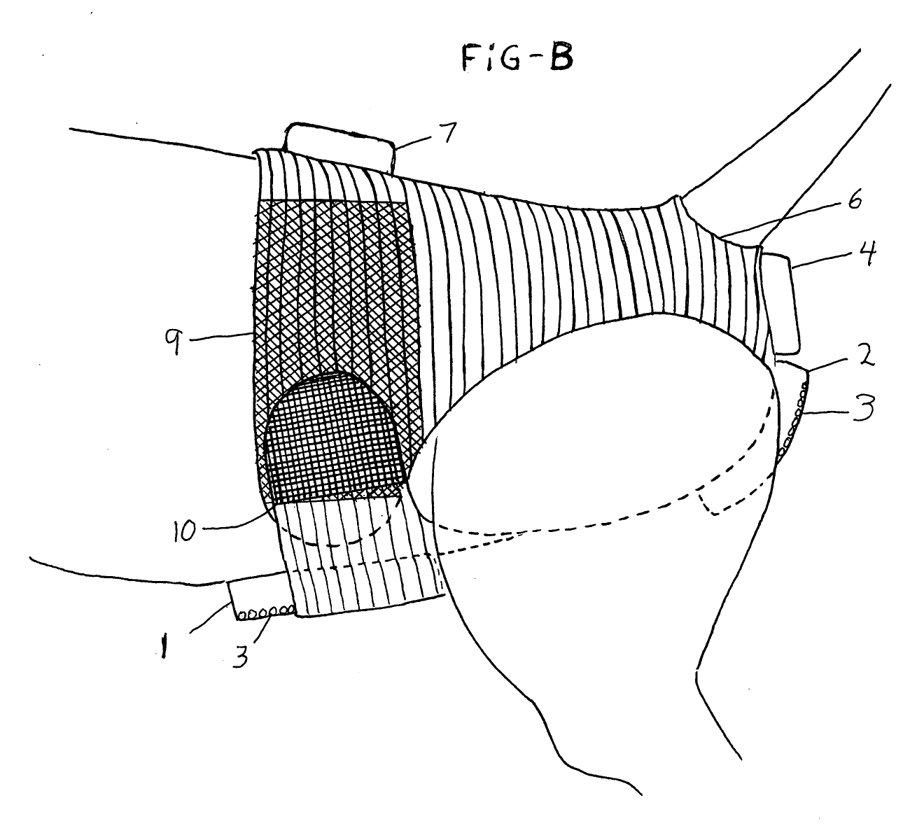

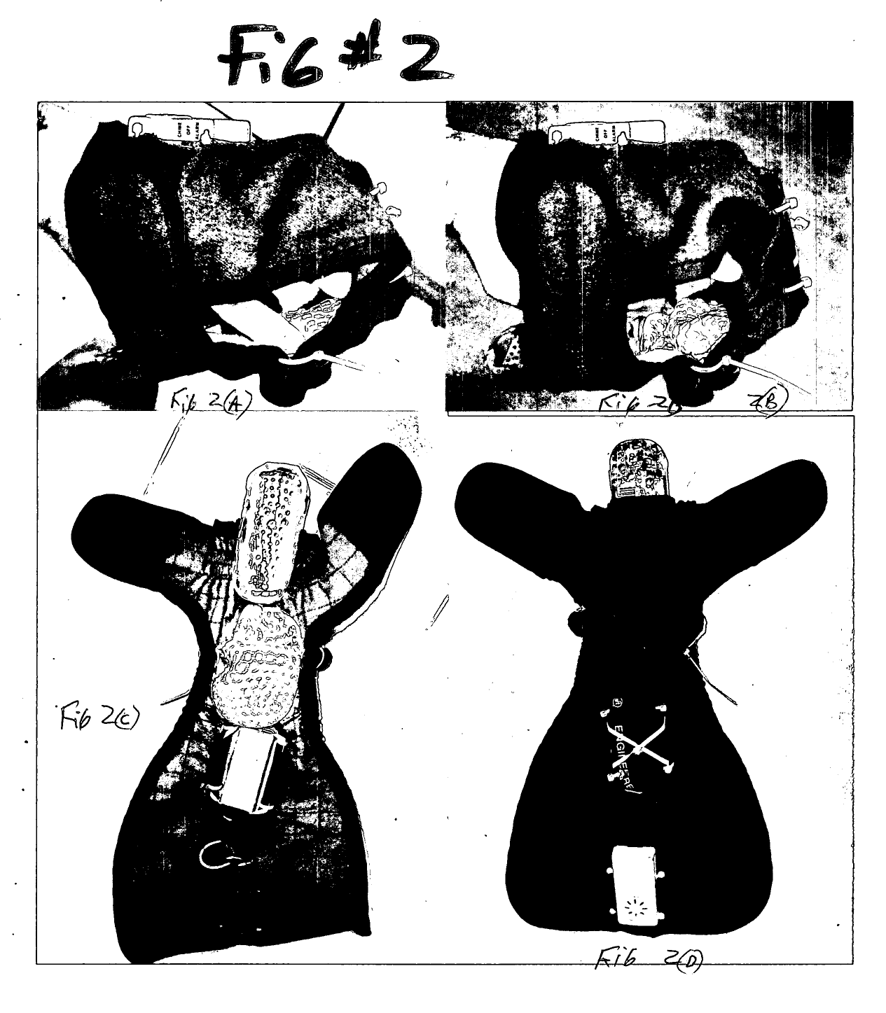

This application based on the provisional application No. 60/849,817 Filed Oct. 06, 2006. by Ian B. Panton

This is a application Ser. No. 11/902,540 Filed Sep. 24, 2007 by Ian B. Panton

### FIELD OF THE INVENTION

This invention relates to an animal behavioral training apparatus, for example for house potty training of domestic animals, particularly but not exclusively to dogs.

Similar items: ‘Simple Solution® Diaper Garments’ diaper garment for potty training but without electronics and without the ability to allow the passage of urine or defecation. It is simply a diaper to catch and contain the elimination of animal, specifically for dogs.

The present invention is directed to an animal behavior training wearable garment with electronic components. It is specifically directed to assist in potty training, or house breaking a domestic animal. The garment comprises of a loud (90 dB) electronic alarm device. The alarm device it triggered when on of two switches are triggered. One switch is activated with the passage of urine stream across two grid plates. Urine contains high concentrations of sodium (salt). This conducts the voltage across the plates/grids, thereby activating the alarm. This is the urine sensing device. The other switch is activated with the puckering of the anus and/or the passage of stool. The stool sensor switch is activated when laser beam is blocked by anus puckering and/or stool passage. All animals' anus puckers before the anal sphincter relaxes and opens to allow passage of stool. Thereby it has the ability to alarm before beginning the defecation process.

This device facilitates all the greatest, well known, potty training key points:
1 Catching them in the act. If you scold or otherwise punish your animal for urination or defecation in the house at any time other than catching them in the act. They will know they are getting punished, and will show and feel shame, but will not associate going potty here is bad. They only know it is bad that there is potty there in front of them because of their short attention span and limited association intelligence. So a well known and constantly stressed potty training point is to catch them in the act of urination/defecation. This device does this every time at the moment it begins.
2 Consistency! Catch them every time. Once garment device is placed the will be unable to urinate or defecate without the garment sounding alarm. Unless the device is switched off by the owner. So this device facilitates consistency!
3 Don't allow urination of defecation odors. These leave marking scents. If animal smells ammonia of urine this acts as a marker of a place to urinate at. It is a well know fact prevent urination/defecation marking odors. If animal does urinate or defecate odors must be completely removed other wise odors flag place at his or her place marked for urination defecation. Keeping garment on at all times prevents ALL/ANY urination/defecation once garment is placed.
4 Startle them to stop urination/defecation. Current best teaching strategy is to catch them in the act and clap hands loudly or throw a tin can with coins in it near them to startle them. This does this same effect with loud electronic alarm (90 dB) each and every time. The beauty of this device is it alarms (works) even if they are trying to be sneaky or sneak out of sight of owner.
5 Rewards for positive action. This notifies owner/trainer of attempt at urination/defecation in house either before, or at very beginning of process. This alarm notifies owner to get animal outside to preferred potty place. Once potty performed in place of preference owner should reward positive behavior with treats. There by animal quickly and easily associates potty inside results in startling and potty outside result in treats/rewards.

### BRIEF DESCRIPTION OF THE DRAWINGS

Embodiments of the present invention will be described more fully herein below, with reference to the accompanying diagrammatic drawings, in which:

FIG. A is a schematic diagram of potty alarm garment. It is shown laid out open looking down on the side that is in contact with animal's skin.

FIG. B is a schematic diagram from side view with garment device applied/drawn on dog. This is intended for use on both male and female dogs. It shows the placement of the 2 urine detection grids, one grid/detector for male anatomy and the other placed grid/detector for female anatomy. Also shows the placement of anal pucker/stool detection device. Also shows wiring and placement of small electronic alarm device.

Description of labeled parts for both Fig A & B:
1 Male urine detector grid
2 Female urine detector grid.
3 Holes in grids to allow passage or urine through detection grids
4 Stool detection window frame.
5 Laser light beam from laser trip sensor system (detector) going across open window.
6. Tail hole in garment to allow animals tail to go through.
7. Alarm circuit with speaker and batteries.
8. Cloth diaper garment.
9. Velcro #9 that meets with Velcro part #10 to secure garment to animal.
10. Velcro #10 that meets with Velcro part #9 to secure garment to animal.
11. Wiring inside garment that connects detector grid plates and laser trip sensor to alarm sounding device.

### DESCRIPTION OF THE PREFERRED DEVICE

Diaper like garment is worn by dog, or other animal. Ideally garment is made for both male and female anatomy. Ideally it has sensors for both male and female urinary anatomy placement. Both of which alarm with the passage of urine, yet allow urine to pass through. The Device has laser trip sensor and small low powered laser inside butt frame to detect, and yet allow, the passage of stool. It has a switch to disarm the alarm once animal is in the preferred elimination location.

Variations and modifications can be made without departing from the scope of the invention described above and as claimed hereinafter.

The invention claimed is:

1. A potty training electronic garment device for animals. A cloth and/or Velcro garment worn on dog as a diaper except modified by removing a hole where cloth catching pad would be expected to be placed. Garments will have urine sensors and or defecation sensor for male, female, or both. Also this garment will have a loud electronic alarm device. Garments may be produced in female only, male only, or both male and female garment. Garments may have optional switch to disarm alarm by owner. Otherwise owner will have to remove and replace garment with each waste elimination.

2. Detects urination and sounds alarm. When urine stream, or even a squirt, goes across (−) grid plate and stream connects to (+) metal pan,—the sodium (salt) in the urine completes the circuit to the alarm devise and sets off the loud electronic audible alarm. When the stream stops, the alarm stops. All urine has high content of salt, sodium, or Na+ secreted by kidneys. Urine, like salt water, is an excellent conductor of electricity.

3. Detects Bowell movement and sounds alarm. Utilizes a small box open frame mounted in garment over animals anus. A small laser beam is bounced across inside the frame to a laser trip sensor. When laser beam is broken, same loud audible alarm is activated. Small, light, low power laser is mounted inside small light weight 7 strong butt frame. Laser used is similar to those like a key chain laser pointer powered by 3 same small pen light batteries. When dog puckers anus to begin stool passage, laser is tripped & alarm is activated. According to Veterinarians, all animals pucker anus before passing stool. This allows alarm notification before beginning! Once animal begins passing stool, they will likely continue to do so. However owner is still notified and able to “catch them in the act”

4. A method of actually catching animal in the act of beginning of urination and/or defecation. Works by notifying owner with loud audible alarm worn by animal in the garment. According to all training videos and veterinarians catching them in the act is the most important aspect of potty training. Most animals will not know what they are being reprimanded for unless caught in the act. They will understand they are in trouble for soiling being there, but not for the fact that they did it there! This device ensures that every elimination will be caught in the act. Consistency! Animal is then placed in proper elimination environment, and then can be given treats as rewards for eliminating where desired.

5. No shock or electricity is felt nor conducted to the animal with urination/defecation. Only 4.5 volts is conducted between the plates only of the urine detector.

6. Alarms when animal tampers with it. If animal places wet nose, mouth, or tongue on outer urine plate, this completes the circuit of the two plates from outer surfaces. This does conduct the voltage through the animal. This usually results in a partial distinctly recognizable whine from electronic loud alarm. This whine can turn to loud full volume alarm if solid enough contact is made from mouth, or nose, to the moist skin of genitailia. on the other side plate. Total voltage used in system is only 4.5v and 180 mAh. From 3 1.5v 60 mAh button cell batteries. So animal does not even notice voltage. It does NOT give a shock to animal.
